(19) United States
(12) Patent Application Publication
(10) Pub. No.: US 2010/0301121 A1
(43) Pub. Date: Dec. 2, 2010

(54) SPECKLE NOISE REDUCING FOR LASER BASED BARCODE READERS

(75) Inventors: Miklos STERN, Woodmere, NY (US); Vladimir Gurevich, Stony Brook, NY (US); Dmitry Yavid, Stony Brook, NY (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Schaumburg, IL (US)

(21) Appl. No.: 12/473,341

(22) Filed: May 28, 2009

(51) Int. Cl. G06K 7/10

(52) U.S. Cl. 235/470

(57) ABSTRACT

A method and apparatus for reducing speckle noise in laser based barcode readers. The apparatus includes a semiconductor laser diode for producing a laser beam. The apparatus also includes electronic circuitry operative to alternate the current passing through the semiconductor laser diode between a current above the threshold current and a current below the threshold current. The current passing through the semiconductor laser diode is alternated with a sufficiently high transition rate for reducing the coherence length of the laser beam.

### FIELD OF THE DISCLOSURE

The present disclosure relates generally to laser based barcode readers.

### BACKGROUND

Bar code readers are known in the prior art for reading various symbologies such as Universal Product Code (UPC) bar code symbols appearing on a label, or on the surfaces of an article. The bar code symbol itself is a coded pattern of graphic indicia comprised of a series of bars of various widths spaced apart from one another to bound spaces of various widths, the bars and spaces having different light reflecting characteristics. The readers electro-optically transform the graphic indicia into electrical signals, which are decoded into information, typically descriptive of the article or some characteristic thereof. Such information is conventionally represented in digital form and used as an input to a data processing system for applications in point-of-sale processing, inventory control, and the like. Readers of this general type have been disclosed, for example, in U.S. Pat. No. 5,600,121, assigned to the same assignee as the instant application, and may employ a portable laser scanning device held by a user, which is configured to allow the user to aim the device and, more particularly, a scanning laser light beam, at a targeted symbol to be read.

The light source in a laser scanning bar code reader is typically a semiconductor laser device. The use of semiconductor devices as the light source is especially desirable because of their small size, low cost and low voltage requirements. The laser beam is optically modified, typically by an optical assembly, to form a beam spot or cross-section of a certain size at a target distance. It is preferred that the cross-section of the beam spot at the target distance be approximately the same as a minimum width between regions of different light reflectivity, i.e., the bars and spaces of the symbol.

In moving laser beam readers known in the art, the laser light beam is directed by a lens or other optical components along a light path toward a target that includes the bar code symbol. The moving-beam reader operates by repetitively scanning the light beam in a scan pattern across the symbol by means of motion of a scanning component, such as a moving mirror placed in the path of the light beam. The scanning component may either sweep the beam spot across the symbol and trace a scan line, or a series of scan lines, or another pattern, across the symbol, or scan a field of view of the reader, or both.

Bar code readers also include a sensor or photodetector which detects light reflected or scattered from the symbol. The photodetector or sensor is positioned in the reader in an optical path so that it has a field of view which ensures the capture of a portion of the light which is reflected or scattered off the symbol. The light is detected and converted into an electrical signal.

Some bar code readers are “retro-reflective”. In a retro-reflective reader, a moving optical element such as a mirror is used to transmit the outgoing beam and receive the reflected light. Non-retro-reflective readers typically employ a moving mirror to transmit the outgoing beam, but have a separate detection system with a wide, static field of view.

Electronic circuitry and software decode the electrical signal into a digital representation of the data represented by the symbol that has been scanned. For example, the analog electrical signal generated by the photodetector is converted by a digitizer into a pulse width modulated digitized signal, with the widths corresponding to the physical widths of the bars and spaces. Such a digitized signal is then decoded, based on the specific symbology used by the symbol, into a binary representation of the data encoded in the symbol, and subsequently to the information or alphanumeric characters so represented. Such signal processors are disclosed in U.S. Pat. No. 5,734,153, assigned to the same assignee as the instant application.

In practice, however, the analog electrical signal generated by the photodetector is already corrupted by speckle noise. Speckle noise is a problem in coherent imaging systems, such as electro-optical readers, when a spatially coherent laser beam is scattered from a rough surface of the paper on which the symbol is printed. Light scattering makes the phase values of the scattered light vary rapidly and create signal intensity variations. When the beam moves along the paper, the number of “speckles” in the field of view of the photodetector varies, thereby leading to random fluctuations in the current of the photodetector. Speckle noise is present even if no symbol is printed on the paper. A detailed analysis of speckle noise properties of a bar code reader can be found in an article by Marom and Kresic-Juric, entitled “Analysis of Speckle Noise in Bar-Code Scanning Systems”, J. Opt. Soc. Am. A, Vol. 18, No. 4, April 2001, pp. 888 901.

Accordingly, there is a need for techniques for reducing speckle noise in laser based barcode readers.

### SUMMARY

In one aspect, the invention is directed to a device for scanning a symbol. The device for scanning a symbol includes a semiconductor laser diode for producing a laser beam, a scan mirror for scanning the laser beam across the symbol, a photodetector for detecting the light reflected from the symbol, and electronic circuitry operative to alternate the current passing through the semiconductor laser diode between a current above the threshold current and a current below the threshold current. The current passing through the semiconductor laser diode is alternated with a transition rate sufficiently high such that the average coherence length of the laser beam generated thereby is at least 10% smaller than the coherence length of an equivalent laser beam when the semiconductor laser diode is operating with a continuous DC current that has the same average current value as the current being alternated.

Implementations of the invention may include the following. The current passing through the semiconductor laser diode can be alternated periodically. The current passing through the semiconductor laser diode can be alternated at a transition rate of at least 40,000,000 times per second.

In another aspect, the invention is directed to a method of reading a symbol. The method includes (1) presenting a device that outputs a laser beam from a semiconductor laser diode; (2) presenting an object with the symbol to the device; (3) aligning the symbol with the device so that the laser beam is incident on the symbol; (4) scanning the laser beam across the symbol with a scan mirror; (5) detecting the light reflected from the symbol with a photodetector; and (6) alternating the current passing through the semiconductor laser diode between a current above the threshold current and a current below the threshold current. The current passing through the semiconductor laser diode is alternated with a transition rate sufficiently high such that the average coherence length of the laser beam generated thereby is at least 10% smaller than the coherence length of an equivalent laser beam when the semiconductor laser diode is operating with a continuous DC current that has the same average current value as the current being alternated.

Implementations of the invention can include one or more of the following advantages. The speckle noise in laser based barcode readers can be reduced.

These and other advantages of the present invention will become apparent to those skilled in the art upon a reading of the following specification of the invention and a study of the several figures of the drawings.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a laser scanner device for reading symbols in accordance with some embodiments.

FIG. 2 depicts an exemplary transfer function of a semiconductor laser diode in which the raw output power of the emitted laser beam is plotted against the drive current flowing through the semiconductor laser diode.

FIG. 3 depicts that a semiconductor laser diode can operate between two operation points when the operating current is modulated with a square wave and changes between a maximum operating current and a minimal operation current.

Table 1 lists the normalized coherence length of the laser beam for selected modulation frequencies as determined in an experimental setup in which a semiconductor laser diode was driven with an operating current modulated with a square wave.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

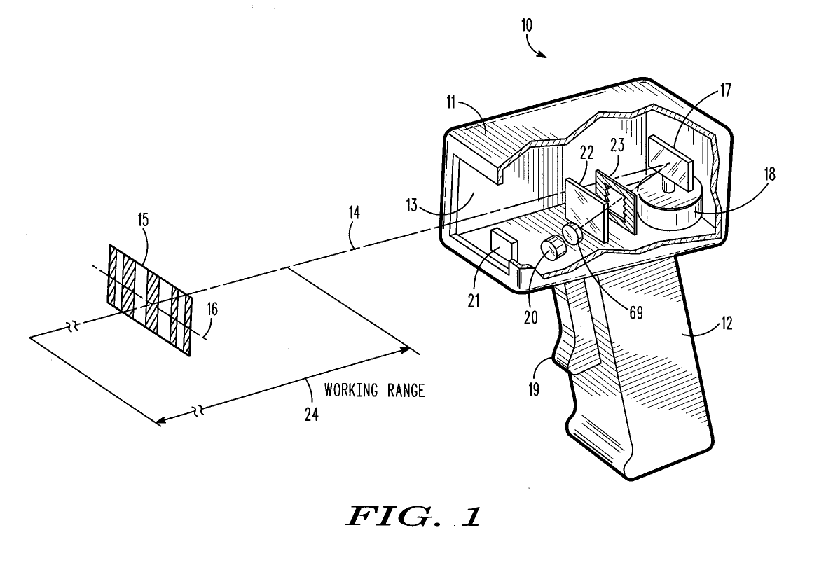

As used herein, the term “symbol” broadly encompasses not only symbol patterns composed of alternating bars and spaces of various widths as commonly referred to as bar code symbols, but also other one- or two-dimensional graphic patterns, as well as alphanumeric characters. In general, the term “symbol” may apply to any type of pattern or indicia which may be recognized or identified either by scanning a light beam and detecting reflected or scattered light as a representation of variations in light reflectivity at various points of the pattern or indicia, or by scanning a field of view and imaging light returning from the symbol onto a sensor array. FIG. 1 shows an indicia 15 as one example of a “symbol” which the present invention can read.

FIG. 1 depicts a laser scanner device 10 for reading symbols. The laser scanner device 10 includes a housing that is generally of the type shown in the above-mentioned patents having a barrel portion 11 and a handle 12. Although the drawing depicts a handheld pistol-shaped housing, the invention may also be implemented in other types of housings such as a desk-top workstation or a stationary scanner. In the illustrated embodiment, the barrel portion 11 of the housing includes an exit port or window 13 through which an outgoing laser light beam 14 passes to impinge on, and scan across, a bar code symbol 15 located at some distance from the housing.

The laser beam 14 moves across the symbol 15 to create a scan pattern. Typically, the scanning pattern is one-dimensional or linear, as shown by line 16. This linear scanning movement of the laser beam 14 is generated by an oscillating scan mirror 17 driven by an oscillating motor 18. If desired, means may be provided to scan the beam 14 through a two-dimensional scanning pattern, to permit reading of two-dimensional optically encoded symbols. A manually-actuated trigger 19 or similar means permit an operator to initiate the scanning operation when the operator holds and aims the laser scanner device 10 at the symbol 15.

The laser scanner device 10 includes a laser source 20, e.g., a gas laser tube or a semiconductor laser diode, mounted within the housing. The laser source 20 generates the laser beam 14. A photodetector 21 is positioned within the housing to receive at least a portion of the light reflected from the bar code symbol 15. The photodetector 21 may face toward the window 13. Alternatively, a convex portion of the scan mirror 17 may focus reflected light on the photodetector 21, in which case the photodetector faces toward the scan mirror. As the beam 14 sweeps the symbol 15, the photodetector 21 detects the light reflected from the symbol 15 and creates an analog electrical signal proportional to the intensity of the reflected light. A digitizer (not shown) typically converts the analog signal into a pulse width modulated digital signal, with the pulse widths and/or spacings corresponding to the physical widths of the bars and spaces of the scanned symbol 15. A decoder (not shown), typically comprising a programmed microprocessor with associated RAM and ROM, decodes the pulse width modulated digital signal according to the specific symbology to derive a binary representation of the data encoded in the symbol, and the alphanumeric characters represented by the symbol.

The laser source 20 directs the laser beam through an optical assembly comprising a focusing lens 69, an optical element 22 and an aperture stop 23, to modify and direct the laser beam onto the scan mirror 17. The scan mirror 17, mounted on a vertical shaft and oscillated by the motor drive 18 about a vertical axis, reflects the beam and directs it through the exit port 13 to the symbol 15.

To operate the laser scanner device 10, the operator depresses trigger 19 which activates the laser source 20 and the motor 18. The laser source 20 generates the laser beam which passes through the element 22 and aperture 23 combination. The element 22 and aperture 23 modify the beam to create an intense beam spot of a given size which extends continuously and does not vary substantially over a range 24 of working distances. The element and aperture combination directs the beam onto the scan mirror 17, which directs the modified laser beam outwardly from the scanner housing 11 and toward the bar code symbol 15 in a sweeping pattern, i.e., along scan line 16. The bar code symbol 15, placed at any point within the working distance 24 and substantially normal to the laser beam 14, reflects a portion of the laser light. The photodetector 21, shown mounted in the scanner housing 11 in a non-retroreflective position, detects the reflected light and converts the received light into an analog electrical signal. The photodetector could also be mounted in a retroreflective position facing the scan mirror 17. The system circuitry then converts the analog signal to a pulse width modulated digital signal which a microprocessor-based decoder decodes according to the characteristics of the bar code symbology rules.

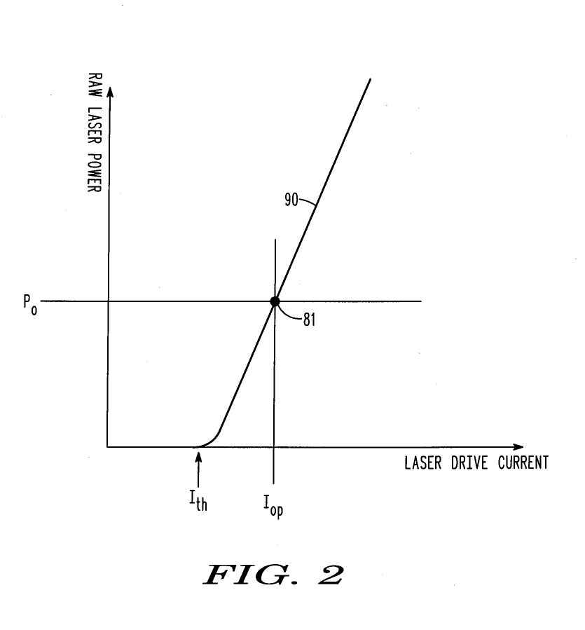

The laser source 20 can be a semiconductor laser diode that has a threshold current. FIG. 2 depicts an exemplary transfer function 90 of a semiconductor laser diode in which the raw output power of the emitted laser beam is plotted against the drive current flowing through the semiconductor laser diode. In order for a semiconductor laser diode to emit coherent light, a drive current must be pumped through the laser diode with a current value exceeding the threshold of lasing operation, commonly referred to as the “knee” of the transfer function. Once this threshold current Iₜₕ is exceeded, additional drive current produces output powers that are directly, or nearly linearly proportional, to the drive current.

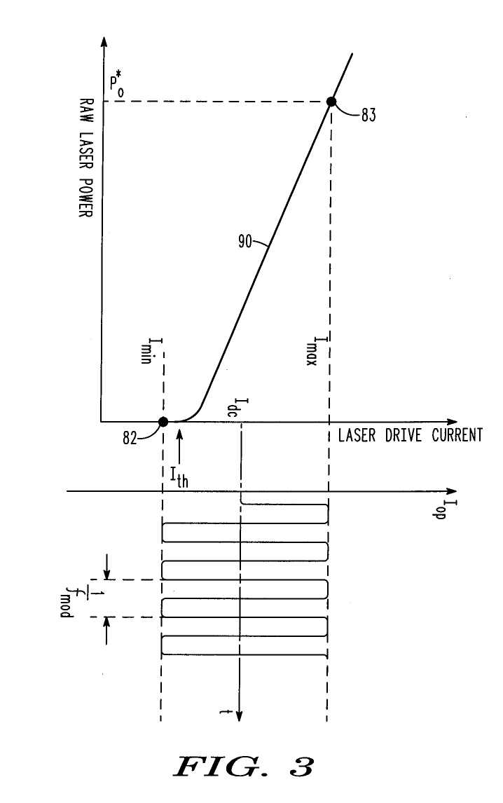

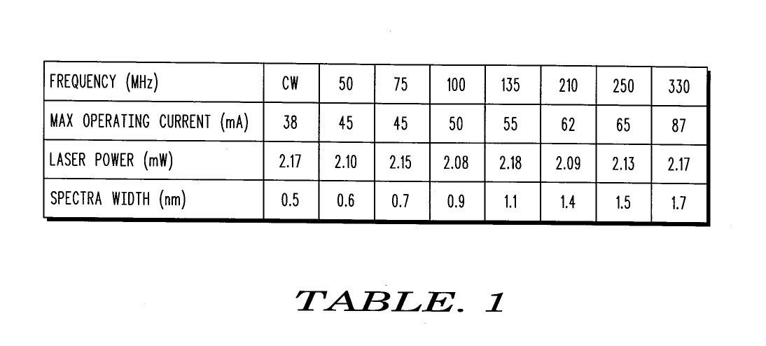

In some of the existing laser scanning barcode readers, the semiconductor laser diode is biased at an operating current Iₒₚ that is nearly constant over time. As shown in FIG. 2, when such nearly constant operating current Iₒₚ is applied to the semiconductor laser diode, the semiconductor laser diode can operate at an operating point 81. At the operating point 81, the raw output power of the emitted laser beam can be at a nearly constant power P₀. Generally, when the operating current Iₒₚ is modulated and changes with time, the raw output power of the emitted laser beam may also be modulated and changed with time. For example, as shown in FIG. 3, when the operating current Iₒₚ is modulated with a square wave and changes between a maximum operating current Iₘₐₓ and a minimal operating current Iₘᵢₙ, the semiconductor laser diode operates between two operation points 82 and 83. If the modulation frequency f_{mod} is not too high such that the semiconductor laser diode has sufficient time to reach a steady state, then, the raw output power of the emitted laser beam can be determined from the transfer function 90 in FIG. 3. For example, when the operating current Iₒₚ is at the maximum operating current Iₘₐₓ, the semiconductor laser diode will be operating at the operating point 83 and the corresponding raw output power of the emitted laser beam will be P₀* as shown in the figure. When the operating current Iₒₚ is at the minimal operating current Iₘᵢₙ, the semiconductor laser diode will be operating at the operating point 82. If the minimal operating current Iₘᵢₙ is smaller than the threshold current Iₜₕ, no laser beam will be emitted from the semiconductor laser diode when operating at the operating point 82. In particular, when the current is below the threshold current, the laser essentially operates like a light emitting diode (LED), which typically has a broad spectrum of several tens of nanometers wide. When the laser is operated above the threshold, the laser has a narrow spectral width, which is typical for lasers. The transient behavior of the laser diode can have influence on the coherence length of the laser emitted. When the drive current is suddenly changed from below the threshold to above threshold, it takes a finite amount of time for the laser to settle into its operating mode as a laser, thus the spectrum of the laser remains wide for some time. If the drive current is switching fast between the operating points from below to above threshold, the optical spectrum of the laser does not have adequate time to settle into its characteristic steady-state mode, and thus its average optical spectrum remains wider than it would be typical for the laser when operating in its steady state. The wider laser spectrum leads to reduced coherence length.

In accordance with one embodiment of the invention, the modulation frequency f_{mod} can be selected to be sufficiently high such that the average coherence length of the laser beam can be reduced. When the coherence length of the laser beam is reduced, the speckle noise due to the coherent nature of the laser beam from the laser source 20 can be reduced as well.

In one experimental setup, a semiconductor laser diode with a center wavelength of about 656 nm was used. The semiconductor laser diode was first driven with a continuous DC current to enable the semiconductor laser diode to operate in the Continuous-Wave (CW) mode; then, the semiconductor laser diode was driven with a modulated current having a modulation frequency. Several modulation frequencies were selected for the experimental setup. The laser power of the semiconductor laser diode under each of the selected operation conditions was monitored. The spectrum of the laser beam emitted from the semiconductor laser diode under each of the selected operation conditions was also measured. In particular, the half-width of the center peak in the spectrum was measured for each of the selected operation conditions. The experimental results are shown in Table 1.

As shown in Table 1, when the semiconductor laser diode was operating in the CW mode, the DC operating current was 38 mA, the laser power was 2.17 mW, and the spectral width of the laser beam was less than 0.5 nm, where the 0.5 nm value was limited by the resolution of the spectrum analyzer used for the measurements. When the operating current is modulated with the modulation frequency of 50 MHz, the maximum operating current was 45 mA, the laser power was 2.10 mW, and the spectral width of the laser beam was 0.6 nm. Because the coherence length of a laser beam is inversely proportional to the spectral width of the laser beam, the ratio between the coherence length of the laser beam generated by the 50 MHz modulation current and the coherence length of the laser beam generated under the CW mode should be less than 0.5 nm/0.6 nm=0.83. Therefore, the coherence length of the laser beam generated by the 50 MHz modulation current was at least 0.83 times smaller than the coherence length of the laser beam generated under the CW mode. That is, the coherence length was reduced by at least 17%. We believe that the actual spectral width of the CW laser diode is significantly narrower than 0.5 nm, and the reduction in coherence length is in turn more significant.

Table 1 also listed the spectral width of the laser beam when the modulation frequency for the operating current was 75 MHz, 100 MHz, 135 MHz, 210 MHz, and 330 MHz. For each of the above operation conditions, the spectral width was respectively equal to 0.7, 0.9, 1.1, 1.4, 1.5, and 1.7. As the modulation frequency increases, the spectral width of the laser beam increases, the coherence length of the laser beam decreases, and the speckle noise due to the coherent nature of the laser beam is expected to decrease as well.

In FIG. 3, the operating current Iₒₚ is modulated with a square wave current offset by a DC current I_{DC}. The duty cycle of the square wave does not have to be 50%. In some implementations, the operating current Iₒₚ can also be modulated with a sine wave or other kind of periodic wave forms. In some implementations, the operating current Iₒₚ can make transitions between the maximum operations current Iₘₐₓ and the minimal operating current Iₘᵢₙ without having fixed periodic wave forms. In Table 1, when the operating current is modulated with the modulation frequency of 50 MHz, the operating current Iₒₚ make transitions between the maximum operating current Iₘₐₓ and the minimal operating current Iₘᵢₙ at a transition rate of 100,000,000 time per second, and the coherence length of the laser beam was reduced by 17% as compared to the coherence length of the laser beam generated under the CW mode. It is expected that, if the operating current Iₒₚ make transitions between the maximum operating current Iₘₐₓ and the minimal operating current Iₘᵢₘ at a rate of 40,000,000 times per second, the coherence length of the laser beam can still be noticeably reduced as compared to the coherence length of the laser beam generated under the CW mode.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A device for scanning a symbol comprising:
a semiconductor laser diode for producing a laser beam, wherein the semiconductor laser diode has a threshold current;
a scan mirror for scanning the laser beam across the symbol;
a photodetector for detecting the light reflected from the symbol; and
electronic circuitry operative to alternate the current passing through the semiconductor laser diode between a current above the threshold current and a current below the threshold current, wherein the current passing through the semiconductor laser diode is alternated with a transition rate sufficiently high such that the average coherence length of the laser beam generated thereby is at least 10% smaller than the coherence length of an equivalent laser beam when the semiconductor laser diode is operating with a continuous DC current that has the same average current value as the current being alternated.

2. The device of claim 1, wherein:
the electronic circuitry is operative to alternate periodically the current passing through the semiconductor laser diode between a current above the threshold current and a current below the threshold current.

3. The device of claim 1, wherein:
the electronic circuitry is operative to generate a modulated current passing through the semiconductor laser diode to reduce the average coherence length of the laser beam.

4. The device of claim 3, wherein:
the modulation frequency of the modulated current is above 50 MHz.

5. The device of claim 3, wherein:
the modulation frequency of the modulated current is above 100 MHz

6. The device of claim 3, wherein:
the modulated current is a square wave current.

7. The device of claim 3, wherein:
the modulated current is a square wave current offset by a DC current.

8. The device of claim 7, wherein:
the duty cycle of the square wave is any one of a value equal to 50%, a value more than 50%, and a value less than 50%.

9. The device of claim 3, wherein:
the modulated current is a sine wave current.

10. The device of claim 3, wherein:
the modulated current is a sine wave current offset by a DC current.

11. A device for scanning a symbol comprising:
a semiconductor laser diode for producing a laser beam, wherein the semiconductor laser diode has a threshold current;
a scan mirror for scanning the laser beam across the symbol;
a photodetector for detecting the light reflected from the symbol; and
electronic circuitry operative to alternate the current passing through the semiconductor laser diode between a current above the threshold current and a current below the threshold current, wherein the current passing through the semiconductor laser diode is alternated at a transition rate of at least 40,000,000 times per second.

12. The device of claim 11, wherein:
the electronic circuitry is operative to alternate periodically the current passing through the semiconductor laser diode between a current above the threshold current and a current below the threshold current.

13. The device of claim 11, wherein:
the electronic circuitry is operative to generate a modulated current passing through the semiconductor laser diode to reduce the average coherence length of the laser beam.

14. A method of reading a symbol, comprising the steps of:
presenting a device that outputs a laser beam from a semiconductor laser diode, wherein the semiconductor laser diode has a threshold current;
presenting an object with the symbol to the device;
aligning the symbol with the device so that the laser beam is incident on the symbol;
scanning the laser beam across the symbol with a scan mirror;
detecting the light reflected from the symbol with a photodetector; and
alternating the current passing through the semiconductor laser diode between a current above the threshold current and a current below the threshold current, wherein the current passing through the semiconductor laser diode is alternated with a transition rate sufficiently high such that the average coherence length of the laser beam generated thereby is at least 10% smaller than the coherence length of an equivalent laser beam when the semiconductor laser diode is operating with a continuous DC current that has the same average current value as the current being alternated.

15. The method of claim 14, wherein the alternating the current passing through the semiconductor laser diode comprises:
alternating periodically the current passing through the semiconductor laser diode between a current above the threshold current and a current below the threshold current.

16. The method of claim 14, wherein the alternating the current passing through the semiconductor laser diode comprises:
generating a modulated current passing through the semiconductor laser diode to reduce the average coherence length of the laser beam.

17. A method of reading a symbol, comprising the steps of:
presenting a device that outputs a laser beam from a semiconductor laser diode, wherein the semiconductor laser diode has a threshold current;
presenting an object with the symbol to the device;
aligning the symbol with the device so that the laser beam is incident on the symbol;
scanning the laser beam across the symbol with a scan mirror;
detecting the light reflected from the symbol with a photodetector; and
alternating the current passing through the semiconductor laser diode between a current above the threshold current and a current below the threshold current at a transition rate of at least 40,000,000 times per second.

18. The method of claim 17, wherein the alternating the current passing through the semiconductor laser diode comprises:
alternating periodically the current passing through the semiconductor laser diode between a current above the threshold current and a current below the threshold current.

19. The method of claim 17, wherein the alternating the current passing through the semiconductor laser diode comprises:
generating a modulated current passing through the semiconductor laser diode to reduce the average coherence length of the laser beam.
